(19) United States
(12) Patent Application Publication
(10) Pub. No.: US 2016/0115578 A1
(43) Pub. Date: Apr. 28, 2016

(54) SYSTEMS AND METHODS FOR PREPARING AND COATING A WORKPIECE SURFACE

(71) Applicant: Dürr Ecoclean GmbH, Filderstadt (DE)

(72) Inventor: Hermann-Josef David, Monschau (DE)

(21) Appl. No.: 14/957,292

(22) Filed: Dec. 2, 2015

Related U.S. Application Data
(63) Continuation-in-part of application No. PCT/EP2014/062488, filed on Jun. 15, 2014.

(30) Foreign Application Priority Data
Jun. 17, 2013 (DE) 102103211324.2

(51) Int. Cl. C23C 4/02; C23C 4/134; C23C 4/131; B05B 1/02; C23C 4/12

(52) U.S. Cl. CPC C23C 4/02; B05B 1/02; C23C 4/12; C23C 4/131; C23C 4/134

(57) ABSTRACT

Systems and methods for preparing and coating a workpiece surface are disclosed. A disclosed method for one or more of working or preparing a surface for coating of a workpiece includes introducing a macroscopic structure into the surface of the workpiece with a tool, where after introducing the macroscopic structure, the surface of the workpiece is to be exposed to a fluid for producing microstructures.

### RELATED APPLICATIONS

This patent arises as a continuation-in-part of International Patent Application No. PCT/EP2014/062488, which was filed on Jun. 15, 2014, and which claims priority to German Patent Application No. 10 2013 211 324, which was filed on Jun. 17, 2013. The foregoing International Patent Application and German Patent Application are hereby incorporated herein by reference in their entireties.

### FIELD OF THE DISCLOSURE

This disclosure relates generally to workpiece surfaces, and, more particularly, to systems and methods for preparing and coating a workpiece surface.

### BACKGROUND

Generally, surfaces that are exposed to great stresses may be finished with coatings to protect them from damage or wear. For example, to finish the surfaces of cylinder bores in the cylinder crankcases of internal combustion engines, the surfaces may be coated by various methods of thermal spraying, such as, for example, LDS coating or plasma coating with a metal alloy. By such known methods, tribological properties of these surfaces may be improved, thereby reducing friction encountered by corresponding piston rings.

### BRIEF DESCRIPTION OF THE DRAWINGS

FIG. 1 shows an example system with a device for preparing a surface of a workpiece for coating, in accordance with the teachings of this disclosure.

FIG. 2 shows an example nozzle tool of the example system of FIG. 1 that is moved in a cylinder bore.

FIG. 3 shows an angle of impingement for a fluid jet emerging from a nozzle of the nozzle tool on the surface of a workpiece.

FIG. 4 shows an enlarged cross-sectional profile view of a surface of a workpiece with a channel-shaped structure.

FIG. 5 shows an enlarged cross-sectional profile view of a surface of the workpiece provided with microstructures after being exposed to a high-pressure fluid jet made up of liquid.

FIG. 6 shows an enlarged plan view of a surface of the workpiece provided with microstructures after being exposed to a high-pressure fluid jet made up of a liquid;

FIG. 7 shows a cross-sectional profile view of a surface of a workpiece with a channel-shaped structure that has undercuts.

FIG. 8 shows a cross-sectional profile view of a surface of a workpiece with a rounded-channel structure.

FIG. 9 shows a cross-sectional profile view of a surface of a workpiece with a rounded-ridge structure.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Systems and methods for preparing and coating a workpiece surface are disclosed. The examples disclosed herein relate to methods for working a surface of a workpiece and/or for preparing a surface of a workpiece for coating, in which a structure such as, for example, a (macroscopic) channel and/or ridge structure, is introduced into/onto the surface of the workpiece with a tool (e.g., a chip-removing cutting tool). Further, the examples disclosed herein relate to a method for finishing the surface of a workpiece, in which the surface of the workpiece is coated. Even further, the examples disclosed herein relate to a system for preparing a surface of a workpiece for coating and also to a system for coating a surface of a workpiece.

Generally, surfaces that are exposed to great stresses may be finished with coatings in order to protect them from damage or wear. For example, to finish the surfaces of cylinder bores in the cylinder crankcases of internal combustion engines, the surfaces may be coated by various methods of thermal spraying, such as, for example, LDS coating or plasma coating with a metal alloy. In such methods, tribological properties of these surfaces may be improved, thereby reducing friction encountered by corresponding piston rings.

In examples with a mechanically stressed coating on a surface, the issue of adhesion of the coating on the surface is particularly relevant.

In order to improve the adhesion properties of a surface of a workpiece of a first material for a coating of a second, different material, it is known to introduce structures into the surface by which the materials applied in a coating process can enter the surface via an interlocking engagement with the surface. To achieve this purpose, in known examples, structures or patterns in the form of channels are introduced via chip-removing cutting tools into the surfaces of cylinder bores in cylinder crankcases, as shown in U.S. Pat. No. 7,621,250 B2 and EP 1 759 132 B1, all of which are hereby incorporated by reference.

To improve the adhesion properties of coatings on the surface of a workpiece, it is also known to roughen the surfaces with abrasive agents, such as, for example, sand or corundum, as shown in DE 10 2011 080 852 A1, which is also hereby incorporated by reference, describes exposing the surface of workpieces to a high-pressure water jet in order to prepare it for coating.

An object of the examples disclosed herein is to provide a method for preparing a surface of a workpiece for coating and to provide a method for finishing the surface of a workpiece by which the adhesive properties of the surface of a workpiece and the adhesion of a coating applied to the surface can be improved significantly.

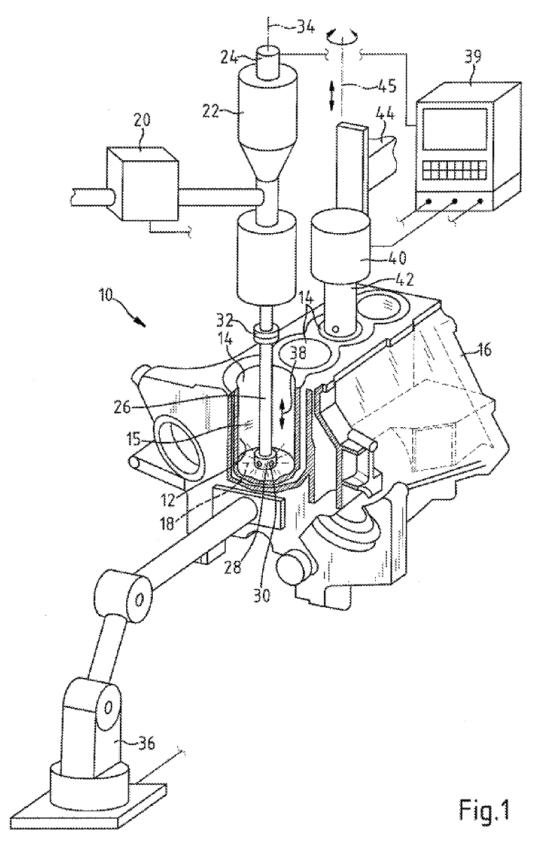

Turning to FIG. 1, in accordance with the teachings of this disclosure, an example system 10 shown in FIG. 1 is designed for working a surface 12 of a cylinder bore 14 in a workpiece formed as an engine block 16 by exposing the surface 12 to pulsating fluid jets 18 of water. For example, water of the fluid jets 18 may contain a cleaning agent, biocide and an anticorrosive, and may be mixed with chemical and/or abrasive constituents.

In the illustrated example of FIG. 1, to produce the fluid jets 18 of water, the example system 10 includes a pumping device 20 and a chamber 22 with a device 24 to produce fluid pressure waves, for example. In this example, the device 24 is coupled to a controllable frequency generator, and contains a piezo crystal, which acts as an electromechanical transducer, and is coupled to a sonotrode, for example. When the chamber 22 is filled with water, pressure waves can be produced by the sonotrode in the water with a frequency, v, which preferably lies in the range of 10 kHz≦v≦50 kHz, for example.

To produce pressure waves, the piezo crystal of the illustrated example is exposed to a high-frequency alternating voltage from a frequency generator, for example. The frequency generator is designed for generating ultrasonic frequencies, preferably ultrasonic frequencies in the range of 10 kHz≦v≦50 kHz. By setting the frequency, v, and the amplitude, A_{P}, of the alternating voltage generated by the frequency generator, the wavelength, λ, and the amplitude of the pressure waves in the line 26 can be varied, for example.

In this example, the line 26 couples the chamber 22 to a nozzle tool 28, which has a nozzle chamber and a number of nozzles 30. However, in some examples, the nozzle tool 28 may also be defined as a nozzle tool with a single nozzle. In some examples, the pressure to which the liquid in the nozzle chamber is exposed may be 600 bar or even significantly higher, for example, such as a pressure of approximately 3000 bar. In this example, the line 26 has a chamber-side portion and a nozzle-side portion. The chamber-side portion and the nozzle-side portion are coupled by a rotary joint 32. In the rotary joint 32 of the illustrated example, the nozzle-side portion can be moved in an oscillating and/or rotating manner about a spindle axis 34 that is coaxial with the line 26 via a motorized rotary drive.

The workpiece 16′ of the illustrated example is mounted on a manipulator 36, which is defined, for example, as a robot and on which it can be displaced in a direction indicated by a double-arrow 38. As a result, it is possible to move the nozzle tool 28 and the workpiece 16′ relative to one another and to expose the surface 12 to pulsating high-pressure fluid jets from the nozzle tool 28.

Further, it may also be provided in an alternative example of the system 10 that the workpiece 16′ is immovably arranged and the nozzle tool 28 mounted on the line 26 is moved relative to the workpiece 16′ in the direction generally indicated by the double-arrow 38 via a manipulator 36. In a particularly preferred example, the workpiece and the nozzle tool are moved relative to one another in such a way that the nozzle tool is moved at an angle other than zero with reference to a channel structure present in the workpiece, thereby allowing the nozzle tool to be used to produce elongated microstructures that cross the macroscopic structure.

The example system 10 includes a control computer 39 with a data memory. The example control computer 39 of the illustrated example is coupled to the pumping device 20, the device 24 that produces fluid pressure waves, the motorized rotary drive in the rotary joint 32, and also the manipulator 36.

The system 10 of the illustrated example includes a measuring device 40 with a confocal microscope 42 to measure the surface 12 of a cylinder bore 14 after the working process with the nozzle tool 28. In this example, the confocal microscope 42 is mounted onto a holding device 44 and can, consequently, be introduced into a cylinder bore 14 of the engine block 16. The example confocal microscope 42 can be rotated about the axis 45 of a cylinder bore 14 and includes an image sensor to record a confocal image of points on the surface 12 of a cylinder bore 14.

In this example, by using the measuring device 40, it is possible to record, in a locally resolved manner, the topography and the properties of the surface 12 in a cylinder bore 14 that are relevant to the adhesion of an applied coating. The measuring device 40 of the illustrated example is coupled to the control computer 39, which, on the basis of the surface topography of the cylinder bore 14 that is recorded with the measuring device 40 after the working with the nozzle tool 28, controls one or more operating parameters of the nozzle tool 28 for working an additional cylinder bore 14 of the same engine block 16 or of another engine block 16, for example. The operating parameters may include the liquid pressure in the nozzle chamber, the rate of advancement of the relative displacement of the nozzle tool 28 and the engine block 16 in the direction of the spindle axis 34, the rotational speed about the spindle axis 34, the pulse frequency of a fluid jet, the pulse duration of a fluid jet from the nozzles 30, the amplitude and/or the power output of the frequency generator acting as an ultrasonic generator for generating pulsed fluid jets.

In accordance with the examples disclosed herein, the workpiece (designed here as an engine block) may, thus, be produced and worked inexpensively in the method steps described above from a lightweight, comparatively soft and/or low-cost material, such as, for example, an aluminum or magnesium alloy. In this example, the method according to the examples disclosed herein not only serves to provide a high-quality surface with a relatively uniform structure and roughness, but can also serve, in particular, to provide a surface prepared for a later coating of a material that is different from the material of the blank.

To improve the tribological properties and to allow a long service life for an engine block produced from an aluminum alloy despite the high temperatures and pressures associated with combustion processes in an internal combustion engine, in this example, the cylinder bores in an engine block according to the examples disclosed herein are coated with a metal alloy in a thermal spraying process. As a result, the weight of the engine block may be reduced, and a lighter material may be chosen as a base material for a blank. In such examples, compact structural forms are made possible such as, for example, cylinder crankcases, in which the cylinder bores are at a reduced distance from one another in comparison with conventional housings.

Use of such a metal alloy of the coating differs significantly from the base material of the engine block by one or more alloy components. For example, the material of the coating may have a carbon content between 0.8 and 0.9 percent by weight, for example, and, in particular, may contain dispersed friction-reducing fillers in the form of graphite, molybdenum sulfide and tungsten sulfide.

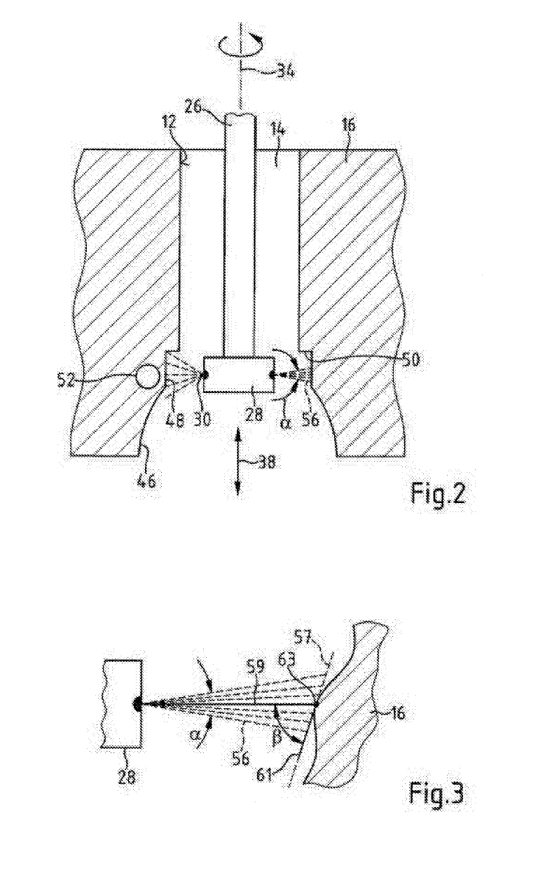

FIG. 2 shows a cross-sectional view of the example engine block 16 of FIG. 1 with the nozzle tool 28. In this example, the cylinder bore 14 is widened on the side of the crankshaft drive 46 and has a honing allowance 48 with an offset 50 and a pulsation bore 52, which allows a pressure equalization between the various cylinder bores 14 in the engine block 16.

By exposing the surface 12 of the cylinder bore 14 while simultaneously displacing the nozzle tool 28 relative to the engine block 16, the surface 12 of the illustrated example may be roughened in a defined manner in its various regions.

In this example, by using the nozzle tool 28, it is possible to roughen (i.e., in particular provide with microstructures) regions of the surface 12 of the cylinder bore, in which a structuring of the surface cannot be brought about with a mechanical cutting tool or by laser working, because these regions, such as, for example, a pulsation bore 52, are not accessible, or only accessible with great difficulty for a cutting or laser tool due to their local geometry.

As shown in the example of FIG. 2, a fluid jet 56 from the nozzle tool 28 has a jet angle, α, which ranges between 10° and 60° and is, preferably, 20°, for example. The jet angle, α, of the illustrated example is the angle defined by the fluid jet 56 after emerging from the opening of the nozzle 30 of the nozzle tool 28. In this manner, the flanks 58 of channels in the surface of a workpiece can also be roughened with the fluid jet and microstructures can, likewise, be produced at these locations by exposure to a fluid jet.

In a modified example of the system, the nozzle tool 28 has multiple nozzle openings, from which a high-pressure fluid jet can emerge with a differing jet angle, a.

FIG. 3 shows the angle of impingement, β, on the surface 12 of the fluid jet 56 emerging from the nozzle tool 28. In the illustrated example of FIG. 3, this angle of impingement, β, is with reference to the average jet direction 57. It corresponds to the angle, β, between the average jet direction 57 and the perpendicular line 61 of the average jet direction 57 to the local tangential plane 59 to the surface 12 at the point of impingement 63 at which the average jet direction 57 intersects the surface 12. A finding related to the examples disclosed herein is that microstructures can be produced particularly efficiently in the surface 12 if the following applies for the angle of impingement β specified above: 70°≦β≦90°.

As a result, the contamination produced on a surface by chip-removing machining in the form of cooling lubricants and chips is removed. Consequently, cleaning the surface in a separate cleaning step before the application of the coating is no longer necessary in some examples. To free a workpiece of remains of liquid before coating, in some examples, the workpiece is exposed to blown air and subsequently dried in a vacuum drier, for example.

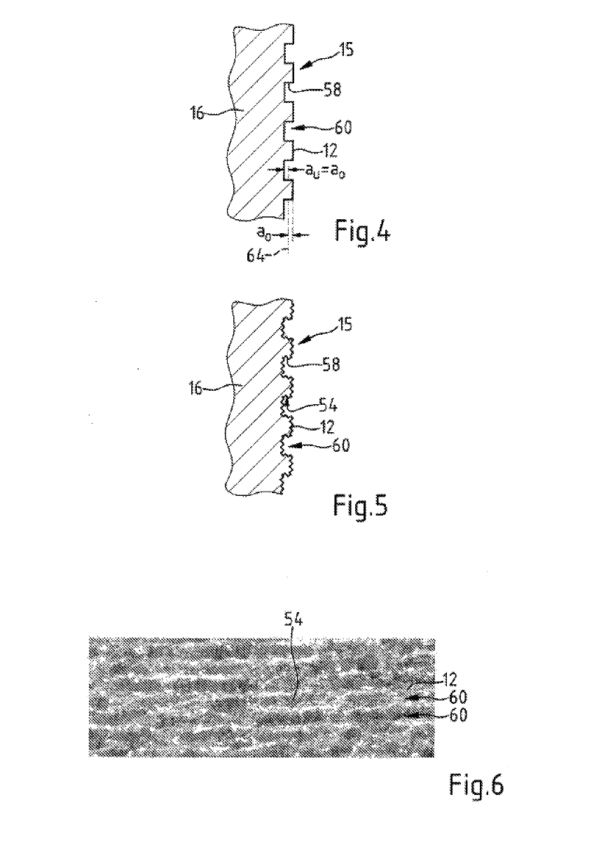

FIG. 4 is an enlarged cross-sectional view of the surface of a workpiece with a structure formed as a channel structure having a multiplicity of channels 60. The channels 60 of the illustrated example are a recessed structure of the surface 12 of the workpiece. In this example, the channels 60 are approximately 50 μm deep and about 100 μm wide. The distance between two channels 60 (i.e., the width of the spine) is approximately 100 μm here.

In this example, the surface 12 has a roughness with reference to the center line 64 with a corresponding roughness value, Rz, which is increased by at least approximately 20% due to the exposure of the surface 12 to the high-pressure fluid jet.

FIG. 5 shows in an enlarged view of the correspondingly roughened surface with microstructures 54 after the exposure to the high-pressure fluid jet from the nozzle tool 28 of the example system 10. In this example, the following relationship applies for the roughness value Rz′ with reference to the center line 64′: Rz′≧1.2×Rz.

FIG. 6 shows an enlarged plan view of the surface 12 of the workpiece provided with microstructures after being exposed to a high-pressure fluid jet made up of a liquid. In this example, in the portions of land or spine, flanks and valleys of the channel structure, there are relatively uniformly distributed microstructures 54, which increase the roughness of the surface 12 (e.g., increase a roughness value of Rz=50 μm of the surface 12 provided with the channel structure before the exposure to the high-pressure fluid jet to a roughness value of Rz′=60 μm after the exposure to the high-pressure fluid jet).

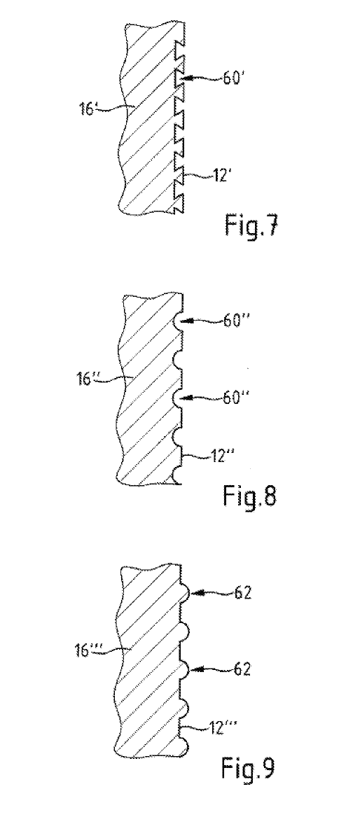

FIG. 7 is a cross-sectional view of another example workpiece 16′, which has a surface 12′ with a channel-shaped structure in the form of dovetail-shaped channels 60′ with undercuts.

In FIG. 8, a cross-sectional view is shown of an example workpiece 16″ with a surface 12,″ in which a structure with a multiplicity of rounded channels 60″ lying next to one another is formed.

FIG. 9 shows an example workpiece 16,′″ which has a surface 12′″ with a structure in the form of many rounded ridges 62 lying next to one another.

It should be noted that, in a modified example from the illustrated example of FIG. 1, the control computer 39 may also contain a computer program with a closed-loop control circuit, by which one or more operating parameters for the nozzle tool 28 for working the surface 12 of a cylinder bore 14 are controlled based on the local topographical properties, or properties that are relevant to the adhesion of an applied coating, which are recorded with the measuring device 40 of a surface 12 in a previously worked other cylinder bore 14 of an engine block 16, for example.

It should additionally be noted that, in some examples, the measuring device 40 may also be formed as a device for measuring the surface 12 of a cylinder bore 14 by the profile method. Furthermore, in some examples, it is also possible to measure the surface of workpieces with an electron microscope to determine the topography of the surface and its properties that are relevant to the adhesion of an applied coating. Even further, it should be noted that the example system 10 may also be formed for the exposure of workpieces to continuous, non-pulsating fluid jets.

To produce microstructures 54 in/on the surface 12 of a workpiece, the system 10 may, for example, be operated with a liquid having water and/or a mixture of water along with a cleaning agent such as, for example, a washing alkaline solution, a mixture of water and biocide, anticorrosive, a water-oil emulsion and/or oil. In some examples, it is also possible to add chemical and/or abrasive constituents to this liquid to increase the effect of a high-pressure fluid jet of the liquid in removing the material of a workpiece. With the example system 10 of FIG. 1, it is also possible to provide fluid jets to act on the surface of workpieces that are not pulsating. With a pulsating fluid jet that emerges from the nozzle tool 28, however, an increased abrasive effect may be achieved relative to the same pressure in the nozzle chamber than with a non-pulsating fluid jet.

In summary, the following preferred features of the examples disclosed herein may be noted in particular. The examples disclosed herein relate to a method for working a surface 12 of a workpiece 16, 16′, 16″, 16′″ and/or to a method for preparing a surface 12 of a workpiece 16, 16′, 16″, 16′″ for coating, in which a structure 15, in particular, a macroscopic structure, for example, such as a channel and/or ridge structure, is introduced into the surface 12 of the workpiece 16, 16′, 16″, 16′″ via a tool. After introducing the structure 15, the surface of the workpiece is exposed to a fluid, in particular, to a liquid, to produce microstructures 54. Additionally, the examples disclosed herein relate to a method of finishing the surface 12 of a workpiece 16, 16′, 16″, 16,′″ in which the surface 12 of the workpiece 16, 16′, 16″, 16′″ is coated once the surface 12 has been prepared by such example methods. Furthermore, the examples disclosed herein relate to a system for preparing a surface 12 of a workpiece 16, 16′, 16″, 16′″ to coat a device and to finish the surface 12 of a workpiece 16, 16′, 16″, 16′″.

The examples disclosed herein propose preparing a surface of a workpiece for coating by introducing a macroscopic structure such as a channel structure, for example, onto/into the surface of the workpiece with a tool and then exposing this surface to a fluid, particularly, an incompressible liquid, for example. By exposing the surface to a fluid in this manner, the macroscopic structure can then be superposed with a microstructure.

A structure (e.g., a macroscopic structure) may be introduced into the surface of the workpiece, in particular, by finish boring (e.g., a chip-removing machining process with a cutting tool in the form of a lathe tool). In principle, the structure may, however, also be produced with any other appropriate type of tool, for example, such as a milling tool, a laser or an electric discharge machining device. The structure takes the form, for example, of a recessed structure (e.g., a recessed macroscopic structure) of the surface. In this example, a surface may be provided with a multiplicity of channels. For example, it is possible for one or more channels to have a channel profile with at least one undercut. In specific configurational variant examples, channel profiles with partially rounded or partially rectangular elevations and/or recesses are provided. In some examples, two undercuts are provided with preference in the region of a recess of a channel, so that, for example, a dovetail-shaped channel profile can be obtained. The channels of a macroscopic structure according to the examples disclosed herein (e.g., a recessed structure) are preferably between 10 μm and 500 μm deep, and between 30 μm and 500 μm, in particular, between 50 μm and 100 μm wide. The channels in the surface of a workpiece may be, for example, at a distance from one another ranging between 30 μm and 500 μm so that there is a flat portion of spine or land (elevation) between the channels. For example, the structure introduced into/onto the surface of the workpiece may be both regular and irregular. The structure may, however, also include a multiplicity of ridges, which are, preferably, formed as rounded ridges in some examples.

To achieve substantially uniform adhesion of a coating on the surface of a workpiece, in some examples, it is a goal to have a substantially uniformly distributed surface roughness in the region of a macroscopic structure, in accordance with the examples disclosed herein. Partial regions with insufficient structuring of the surface may lead to later detachment of the coating. Uniformly distributed surface roughness and/or uniform surface structure on workpieces are also advantageous for other reasons, for example, such as corrosion avoidance, or for optical purposes, etc.

It has been determined that in certain areas of application, a structuring of the surface of a workpiece with a required channel depth and quality cannot be reliably ensured in industrial mass production, or only with very great effort, with chip-removing machining processes, in which the surface of a corresponding workpiece is machined with a cutting tool. One possible cause is that a channel or groove produced with a rotating cutting tool in the surface of a bore, for example, such as a cylinder bore, has a depth that is dependent on the roundness of this bore. It has been determined in practice that this dependency results from the roundness of cylinder bores in industrially produced engine blocks is subject to certain variations. As a result, in examples where surfaces are set back from a standard dimension, a cutting tool rotating about an axis has a reduced depth of penetration into the workpiece material, which can lead to a smaller depth of the structure.

Further application areas for the methods according to the examples disclosed herein are surfaces of a workpiece that are not optimally accessible for a cutting tool or some other tool for chip-removing working because of the geometry of the surface. For example, structuring the surface of a workpiece with a required channel depth and quality in industrial mass production may only be reliably ensured with significant effort if the surface to be structured is relatively small in relation to the tool and/or is positioned in a recess. In certain regions of workpieces, such as, for example, engine blocks, the introduction of structures into/onto the surface of the workpiece with a rotating mechanical cutting tool may not be possible, or may require a very significant effort. This applies, for example, to cast cylindrical bores for the mounting of a crankshaft, pulsation bores and bevels in cylinder bores, and also, overhangs or reliefs with a relatively great diameter (e.g., honing allowance).

It has been determined, in particular, that the adhesive properties of the surface for a coating and the adhesion of a coating applied to the surface, but also other qualitative properties of a surface, can be improved if an additional microstructure is introduced into the surface of a workpiece provided with a macroscopic structure. In this respect, it is envisioned according to the examples disclosed herein to produce the macroscopic structure particularly with a chip-removing, mechanical roughening or machining process and subsequently to after-treat it with a fluid. In this way certain macroscopic structures produced with a rotating cutting tool on the surface of a workpiece such as, for example, channel-shaped structures in a cylinder liner of an engine block, can be advantageously improved by superposing with a microstructure. In some examples, the microstructure is produced with the aid of an abrasively acting fluid. In these examples, the fluid is capable of reaching surfaces that may not be reached by another tool. In particular, portions of land that lie between two (macroscopic) grooves and in which the surface may remain unworked in the first method step can be additionally structured. This leads not only to a general improvement in the quality of the surface, but also, in particular, to particularly advantageous engagement of a coating applied to such a surface with the surface. Additionally or alternatively, other surface features, such as, for example, the hardness of the surface, may also be modified, for example.

In some examples, preferably, a microstructure is introduced into the macroscopic structure by a fluid being directed onto the surface of the workpiece in the form of a fluid jet through one or more openings of a nozzle tool, for example. In a particularly preferred example, the nozzle tool has a nozzle chamber, in which the fluid or the liquid is exposed to a pressure that is greater than 100 bar, preferably greater than 150 bar, and with particular preference to ranging greater than 300 bar, which in particular lies between 2000 bar and 4000 bar and, thus, can be 3000 bar, for example. In some examples, the nozzle tool and/or the workpiece is/are moved in/along a certain path relative to one another during the exposure of the workpiece. For example, the path mentioned is chosen at an angle other than zero relative to a number of channels of the macroscopic structure. In another example, the fluid jet is applied to the surface of the workpiece with a pressure that varies over time.

According to the examples disclosed herein, the microstructures provided may for example have a conical, hemi-spherical, spherical, trough-shaped or channel-shaped in a basic form. In a preferred example, the microstructures have, at least in certain portions, a circular contour with a diameter that is preferentially between 1 μm and 50 μm. The microstructures may, for example, be 1 μm to 50 μm deep. The microstructure introduced into/onto the surface by the fluid jet is a substructure with respect to the structure in the surface. In other words, the dimensions of the microstructure introduced into the surface by the at least one fluid jet are significantly smaller than the dimensions of the macroscopic structure in the surface before the exposure to the fluid.

It has been discovered that the erosive effect of a fluid jet acting on the surface of a workpiece and comprising a fluid and/or a liquid is increased if there are structures in the surface that are in the form of recesses between 10 μm and 500 μm deep and between 30 μm and 500 μm wide, in particular, for example, between 50 μm and 100 μm wide. It has been found in extensive tests that such recesses in the surface of a workpiece have the effect that the impulse of so-called cross jets (e.g., the impulse of fluid jets that run transversely to the normal to the surface of the workpiece) can also be transferred to the workpiece.

According to the examples disclosed herein, the roughness of the surface of a workpiece provided with a structure is increased by the exposure to the fluid or the liquid.

As used herein, a roughness of a surface is understood to mean the arithmetic mean of the average distance of a set of measuring points arranged on the surface from a center line or center area on which the sum of the deviations from the surface is minimal for the measuring points.

In this example, the roughness of the surface of a workpiece is increased by the exposure to the fluid or the liquid means that the surface of the workpiece can, thus, be increased in size so that there is an increase in the sum of the forces of adhesion by which a coating applied to the surface of the workpiece is securely held onto the surface.

Because the surface of the workpiece is exposed to a liquid means, it is also possible to achieve the effect that this surface is cleaned of any soiling with cooling lubricants and chips remaining from machining, in particular, chip-removing machining in a previous working step.

In particular, it has been discovered that a fluid in the form of a liquid made up of water and/or a mixture of water and cleaning agent, for example, a washing alkaline solution, a mixture of water and biocide and/or anticorrosive and/or a water-oil emulsion, and/or oil is particularly well suited for carrying out the method in accordance with the examples disclosed herein. For example, exposing a surface of a workpiece to a high-pressure fluid jet of the liquid by producing microstructures in the surface of the workpiece according to the examples disclosed herein, enables a secure connection between the workpiece and the coating, thereby increasing adhesive attachment of a coating on the surface.

To facilitate or speed up the production of microstructures in the surface of a workpiece provided with a macroscopic structure, fluid or liquid may be mixed with chemical and/or abrasive constituents. In a preferred example, the fluid used is compressed air that contains as additional abrasive constituents grains of sand, particles of plastic, particles of glass, corundum, water ice and/or CO₂ ice.

It is also a finding of the examples disclosed herein that, if the at least one fluid jet for acting on the surface of a workpiece has a jet angle that ranges between 10° and 60° and is preferably 20°, the desired microstructures can be formed in the surface of the workpiece, in particular, in the flanks of macroscopic channels or recesses, which further improves the adhesion of a coating applied to the surface of the workpiece. A good erosive effect can be achieved, in particular, if the fluid jet has a jet direction which impinges on the surface at an angle of impingement β with reference to a local tangential plane to the surface where 70°≦β≦90°. A particularly good erosive effect of the fluid jet may be achieved if the fluid jet is produced by a flat-jet nozzle or a hollow-cone jet nozzle, for example. In some examples, a flat jet nozzle allows the provision of a fan-shaped, flat fluid jet. In other examples, with a hollow-cone jet nozzle, it is possible to generate a fluid jet in the geometry of the lateral surface of a hollow cone. However, in some examples, the fluid jet may also be produced with a full-jet nozzle.

Another aspect in accordance with the examples disclosed herein is to expose the surface of a workpiece simultaneously or successively to a fluid jet, which is directed onto the surface of the workpiece at different jet angles, α, and/or different angles of impingement, β.

As used herein, the jet angle, α, is understood as meaning the angle defined by the fluid jet after emerging from the opening of a nozzle of the nozzle tool.

As used herein, the angle of impingement, β, is the angle between the average jet direction and the perpendicular line of the average jet direction to the local tangential plane to the surface at the point of impingement of the fluid jet at which the average jet direction intersects the surface.

A further aspect of the examples disclosed herein is to set one or more operating parameters for the nozzle tool, and thereby, in particular, the properties of the at least one fluid jet acting on the surface of the workpiece based on intrinsic and/or extrinsic nature and/or properties of the surface. As used herein, the intrinsic nature of the surface is understood to mean the material and the microstructure of the material, the structure of the surface, the grain structure of the material of the surface, the hardness and roughness of the surface of the workpiece, and also, for example, a concentration of air bubbles or voids in the region of the surface of the workpiece. As used herein, the extrinsic nature of the surface of the workpiece is understood to mean the local geometry of the surface, such as, for example, surface curvatures, undercuts, projecting and set-back structures, such as, for example, with a honing allowance for a cylinder bore in an engine block.

In some examples, the set nozzle-tool operating parameters may be, for example, a liquid pressure of the fluidic medium in the nozzle chamber and/or a rate of advancement of the nozzle tool relative to the workpiece in the direction of a spindle axis, a rotational speed of the nozzle tool about the spindle axis, a pulse frequency of the liquid jet, a pulse duration of the liquid jet, an amplitude and/or a power output of an ultrasonic generator for generating the pulsed fluid jet. The nature of the at least one fluid jet may be for example the speed and the consistency of the fluidic medium that emerges from a nozzle opening in the nozzle tool.

In some examples, properties of the at least one fluid jet to act on the surface of the workpiece are set based on the local intrinsic and/or extrinsic nature of the surface.

For example, the local intrinsic and extrinsic nature of the surface of the workpiece may, for example, be known and stored in a data memory. However, it is also possible to determine the nature of the surface of the workpiece before or after, also possibly during, the exposure to a fluid jet in a, preferably, non-destructive measuring process, for example by measuring in a profile method, in which a stylus, preferably having diamond, for example, is moved at a relatively constant speed over the surface and a positional displacement of the stylus is then recorded by a displacement measuring system such as, for example, an inductive displacement measuring system. The nature of the surface of the workpiece may, however, also be determined by measuring with a confocal measuring system, as described for example in the publication by M. Weber and J. Valentin in the QZ Qualitat and Zuverlassigkeit [German quality and reliability journal] 5, 51 (2006), which is hereby incorporated by reference and the disclosure of which is included in the description of the present disclosure, or by measuring the surface of the workpiece with a microscope, for example, such as a scanning electron microscope.

In some examples, setting one or more nozzle-tool operating parameters based on the location of the surface exposed to at least one fluid jet, the orientation of the fluid jet with respect to the surface and/or the extrinsic and/or intrinsic nature of the surface and/or the measured structural features of the surface of the workpiece that are relevant to the adhesion of an applied coating, an identical workpiece of which the surface has already been prepared for coating, and/or the structural features of the surface that are relevant to the adhesion of an applied coating and have been stored in a data memory, allows a compensating adjustment to be made for any absent or insufficient structuring of the surface of a workpiece. In some examples, after such a compensating adjustment, a coating may be applied to the structured surface of the workpiece despite local differences in the geometry, the form and/or the depth of a structure produced on the surface of a workpiece with the coating adhering particularly well, thereby achieving, in particular, a relatively uniform adhesion of the coating on the surface of the workpiece, for example.

To avoid a thermal coating of the surface of the workpiece being impaired by remaining liquid, it is advantageous, in some examples, if the surface is treated with blown air and/or is dried by vacuum drying before coating, for example.

A surface of a workpiece prepared according to the examples disclosed herein for coating is suitable, in particular, for thermal coating, for example. In particular, coating is accomplished via a thermal spraying process, LDS coating, plasma coating, wire arc spraying or flame spraying, for example.

According to the examples disclosed herein, in this manner, the surface or the wall of a cylinder bore in an engine block or in a cylinder housing or in a crankshaft housing may be finished by coating, for example.

In some preferred examples, the preparation of the surface of a workpiece for coating is carried out in a number of successive steps. For example, in a first step, the surface of the workpiece is mechanically structured in the regions that can be reached with a cutting tool. In a second step of this example following the first step, the surface of the workpiece is then exposed to a high-pressure fluid jet of a fluid, in particular, a liquid, to produce microstructures in the surface of the workpiece. In some examples, in an optional third step following the second step, the surface of the workpiece is flushed with liquid or gaseous fluid. Additionally or alternatively, in an additional/optional step, the workpiece is after-treated, for example, with blown air in a subsequent method step and/or is freed of liquid remaining in a vacuum drier, for example.

Another aspect of the examples disclosed herein is to provide a method for working a plurality of workpieces in a preferably industrial process of a working or roughening process, in which macroscopic structures are produced in the surface of a workpiece, is followed by performing an automated, preferably contactless measurement of the topography and/or the structural features of a workpiece surface that are relevant to the adhesion of an applied coating. In this example, a workpiece surface is measured, for example, in a profile method to set, in an automated closed-loop control circuit, one or more parameters to introduce microstructures via a fluid jet, for example. In some modified example methods for working a plurality of workpieces, a roughening process, in which microstructures are produced in the surface of a workpiece, is followed by performing a measurement of the topography and/or the structural features of a workpiece surface that are relevant to the adhesion of an applied coating. In these examples, a workpiece surface is measured in order then to set in a closed-loop control circuit one or more parameters for the introduction of microstructures via a fluid jet, for example.

Additionally or alternatively, to measure the surface in a profile method, the surface may, for example, also be measured using a confocal measuring system, a microscope or an electron microscope, for example.

As part of an industrial process in which a number of identical workpieces are thus treated identically one after another for introducing microstructures according to the examples disclosed herein, based on the measurement of a first workpiece or based on the measuring results obtained on the first workpiece, the parameters to introduce microstructures via a fluid jet on other workpieces may be set. This repeated performance of setting the parameters then provides, according to the examples disclosed herein, an optimization and/or improvement in setting the fluid jet to introduce microstructures. In some preferred examples, the fluid jet is continuously optimized and/or improved by one or more parameters, allowing the introduction of microstructures into the surface of the measured workpiece, or at least one workpiece following thereafter, to be optimized and/or improved dependent on the measured values for the topography or the structural features of the surface that are relevant to the adhesion of an applied coating.

Example methods disclosed herein to work a plurality of workpieces in a preferably industrial process enables reduction of process times, improve the quality of machined or roughened surfaces of a workpiece, optimizes and/or improves the adhesion values of coatings and, additionally, also clean the surface of a workpiece.

The examples disclosed herein also extend to systems for preparing a surface of a workpiece for coating and/or for finishing the surface of a workpiece by coating. In such systems according to the examples disclosed herein, a fluid or a liquid can be provided onto the surface of the workpiece, preferably with a nozzle tool, which has a nozzle body that is rotatable about a spindle axis and displaceable along the direction of the spindle axis, including a nozzle chamber and at least one nozzle opening for the provision of at least one continuous or pulsed fluid jet. In some examples, it is advantageous if the nozzle tool is assigned an open-loop and/or closed-loop control device to set at least one nozzle-tool operating parameter such as, for example, a nozzle-tool operating parameter from the group including fluid pressure/liquid pressure in the nozzle chamber, rate of advancement in relation to the workpiece in the direction of the spindle axis, rotational speed about the spindle axis, pulse frequency of the fluid jet/liquid jet, pulse duration of the fluid jet/liquid jet, amplitude and/or power output of an ultrasonic generator for generating a pulsed fluid jet. Such open-loop and/or closed-loop control devices may serve the purpose of setting the at least one nozzle-tool operating parameter based on the location of the surface, the geometry of the surface and/or the intrinsic or extrinsic nature of the surface. In some examples, this setting may take place, in particular, based on measurement data recorded on a workpiece other than the one being worked at the time in the system, for example, in particular, a workpiece that has already been worked in the system (i.e., a workpiece on which the working in the system has been completed).

In an example method for working a surface 12 of a workpiece 16, 16′ and/or for preparing a surface 12 of a workpiece 16, 16′ for coating, a structure 15, in particular a macroscopic structure such as, for example a channel and/or ridge structure, is introduced into the surface 12 of the workpiece 16, 16′) with a tool, where after introducing the structure 15, the surface 12 of the workpiece 16, 16′ is exposed to a fluid, in particular, to a liquid for producing microstructures 54.

In some examples, the roughness of the surface 12 is increased at least in certain portions by the exposure to a fluid or a liquid. In some examples, the fluid is directed as at least one pulsating or continuous fluid jet 56 onto the surface 12 of the workpiece 16, 16′, the fluid jet 56 being produced by one or more nozzles 30 of a nozzle tool 28, the nozzle tool 28 having, in particular, a nozzle chamber in which the fluid or the liquid is exposed in particular to a pressure that is greater than 100 bar, preferably greater than 150 bar, with a particular preference of greater than 300 bar, and which, in particular, lies between 2000 bar and 4000 bar and is, for example, 3000 bar.

In some examples, a liquid made up of water and/or a mixture of water and cleaning agent, for example, a washing alkaline solution, and/or a mixture of water and biocide and/or anticorrosive and/or a water-oil emulsion and/or oil is selected as the fluid. In some examples, the fluid is mixed with chemical and/or abrasive constituents.

In some examples, the at least one fluid jet 56 is produced by a flat-jet nozzle or a hollow-cone jet nozzle or a full-jet nozzle and has a jet angle α, which lies between 10° and 60° and is, preferably, 20°, and/or in that the fluid jet 56 with an average jet direction 57 impinges on the surface 12 at a point of impingement 63 at an angle of impingement, β, which corresponds to the angle between the average jet direction 57 and the perpendicular line 61 of the average jet direction 57 to the local tangential plane 59 at the point of impingement 63, the following applying for the angle of impingement, β: 70°≦β≦90°.

In some examples, the surface 12 is exposed simultaneously or sequentially to fluid jets 56, which have a differing jet angle, α, and/or a jet direction 57 with a differing angle of impingement, β, on the surface 12.

In some examples, at least one operating parameter for the nozzle tool 28 is set in dependence on an intrinsic or extrinsic nature of the surface 12 of the workpiece 16, 16′ that is measured or stored in a data memory or is set in dependence on a measured intrinsic or extrinsic nature of the surface 12 of another workpiece of which the surface 12 has already been prepared for coating by exposure to a pulsating or continuous fluid jet 56 from the nozzle tool 28 before the surface of the workpiece.

In some examples, the operating parameter for the nozzle tool 28 is a nozzle-tool operating parameter from the group comprising fluid pressure/liquid pressure in a nozzle chamber, rate of advancement of a nozzle tool 28 in the direction of a spindle axis 34, rotational speed of a nozzle tool 28 about a spindle axis 34, pulse frequency of the fluid jet 56, pulse duration of the fluid jet 56, amplitude and/or power output of an ultrasonic generator and/or in that the nature of the surface 12 of the workpiece 16, 16′ or of the other workpiece is determined in a non-destructive measuring process, preferably in a non-destructive measuring process from the group comprising profile methods, confocal imaging with a microscope, imaging with an electron microscope.

In some examples, the at least one operating parameter for the nozzle tool 28 is set in dependence on the location of the surface 12 and/or the geometry of the surface 12 and/or the intrinsic or extrinsic nature of the surface 12 and/or the measured structural features of the surface of the workpiece 16, 16′ that are relevant to the adhesion of an applied coating, or of an identical workpiece 16, 16′ of which the surface has already been prepared for coating, or the relevant structural features of the surface that have been stored in a data memory.

In some examples, before and/or after the exposure to a first fluid, in particular in the form of a liquid, the surface 12 of the workpiece 16, 16′ is flushed with a second fluid, which is different from the first fluid. In some examples, the structure 15 comprises a multiplicity of channels 60, 60′, 60″ with a channel profile that is rectangular and/or round and/or has at least one undercut, with preference two undercuts, and is preferably dovetail-shaped and/or comprises a multiplicity of ridges, which are preferably formed as rounded ridges 62.

In an example method for finishing the surface of a workpiece, in which the surface 12 of the workpiece 16, 16′ is coated, the surface 12 is prepared before the coating using the example methods disclosed herein.

In some examples, before the coating, the surface 12 of the workpiece 16, 16′ is after-treated, in particular dried, by treating with blown air and/or by vacuum drying. In some examples, the surface 12 of the workpiece 16, 16′ is coated by means of a thermal spraying process, in particular by means of LDS coating or plasma coating or wire arc spraying or flame spraying. In some examples, the surface 12 of the workpiece 16, 16′ is a wall of a cylinder bore in an engine block or in a cylinder housing or in a crankshaft housing.

An example system 10 for preparing a surface 12 of a workpiece 16′ for coating, in particular, a system for carrying out the method defined above and/or a method for finishing the surface of a workpiece as defined above, where a fluid or a liquid can be fed onto the surface 12 of the workpiece 16, 16′ includes a nozzle tool 28, which has a nozzle body that is rotatable about a spindle axis 34 and displaceable in relation to the workpiece 16, 16′ in the direction of the spindle axis 34, comprising a nozzle chamber and comprising at least one nozzle opening 30 for the provision of at least one continuous or pulsed fluid jet 56, an open-loop and/or closed-loop control device 39 being provided for the nozzle tool 28, for the setting of at least one nozzle-tool operating parameter from the group comprising fluid pressure/liquid pressure in the nozzle chamber, rate of advancement in the direction of the spindle axis 34, rotational speed about the spindle axis 34, pulse frequency of the fluid jet 56, pulse duration of the fluid jet 56, amplitude and/or power output of an ultrasonic generator for generating a pulsed fluid jet 56 in dependence on the location of the surface 12 and/or the geometry of the surface 12 and/or the intrinsic or extrinsic nature of the surface 12 of the workpiece 16′ or the structural features of another workpiece from a series of workpieces with a surface already prepared for coating that have been measured with a measuring device 40 connected to the open-loop and/or closed-loop control device 39 for the locally resolved measurement of the structural features that are relevant to the adhesion of an applied coating.

An example method for one or more of working or preparing a surface for coating of a workpiece includes introducing a macroscopic structure into the surface of the workpiece with a tool, where after introducing the macroscopic structure, the surface of the workpiece is to be exposed to a fluid for producing microstructures.

In some examples, the fluid includes a liquid. In some examples, the macroscopic structure is one or more of a channel or a ridge structure. In some examples, the roughness of the surface is increased at least in certain portions by the exposure to one or more of the fluid or a liquid. In some examples, the fluid is directed as at least one pulsating or continuous fluid jet onto the surface of the workpiece, the fluid jet being produced by one or more nozzles of a nozzle tool, where the nozzle tool has a nozzle chamber in which the fluid or the liquid is exposed to a pressure that is greater than 100 bar.

In some examples, the fluid includes a liquid including one or more of water, a mixture of water and cleaning agent, a washing alkaline solution, a mixture of water and biocide, anticorrosive, a water-oil emulsion, or oil. In some examples, the fluid is mixed with one or more of chemical or abrasive constituents. In some examples, the at least one fluid jet is produced by a flat-jet nozzle or a hollow-cone jet nozzle or a full-jet nozzle and has a jet angle, α, which lies between 10° and 60°, and/or the fluid jet with an average jet direction impinges on the surface at a point of impingement at an angle of impingement, β, which corresponds to the angle between the average jet direction and the perpendicular line of the average jet direction to the local tangential plane at the point of impingement, where the angle of impingement, β, is approximately 70° β≦90°.

In some examples, the surface is exposed simultaneously or sequentially to fluid jets, which have a differing jet angle, α, and/or a jet direction with a differing angle of impingement, β, on the surface. In some examples, at least one operating parameter for the nozzle tool is set based on dependence on an intrinsic or extrinsic properties of the surface of the workpiece that is measured or stored in a data memory or is set based on a measured intrinsic or extrinsic properties of the surface of another workpiece of which the surface has already been prepared for coating by exposure to a pulsating or continuous fluid jet from the nozzle tool before the surface of the workpiece.

In some examples, the operating parameter for the nozzle tool is a nozzle-tool operating parameter from the group consisting of fluid pressure/liquid pressure in a nozzle chamber, rate of advancement of a nozzle tool in the direction of a spindle axis, rotational speed of a nozzle tool about a spindle axis, pulse frequency of the fluid jet, pulse duration of the fluid jet, amplitude, power output of an ultrasonic generator and/or in that the properties of the surface of the workpiece or of the other workpiece is determined in a non-destructive measuring process.

In some examples, the properties of the workpiece or of the other workpiece is determined in a non-destructive measuring process from the group consisting of profile methods, confocal imaging with a microscope, or imaging with an electron microscope. In some examples, the at least one operating parameter for the nozzle tool is set based on one or more of the location of the surface, the geometry of the surface, the intrinsic or extrinsic properties of the surface, the measured structural features of the surface of the workpiece that are relevant to the adhesion of an applied coating, of an identical workpiece of which the surface has already been prepared for coating, or the relevant structural features of the surface that have been stored in a data memory.

In some examples, where before and/or after the exposure to a first fluid, the surface of the workpiece is to be flushed with a second fluid different from the first fluid. In some examples, the structure includes a multiplicity of channels with a channel profile that is one or more of rectangular, round, or has at least one undercut. In some examples, the channel profile includes two undercuts. In some examples, the channel profile is at least one of dovetailed shaped or comprises a multiplicity of ridges.

In an example method for finishing the surface of a workpiece, in which the surface of the workpiece is coated, where the surface is prepared before coating by a method as defined above.

In some examples, before the coating, the surface of the workpiece is dried by treating with one or more of blown air or by vacuum drying. In some examples, where the surface of the workpiece is coated by a thermal spraying process. In some examples, the thermal spraying process includes LDS coating, plasma coating, wire arc spraying or flame spraying. In some examples, the surface of the workpiece is a wall of a cylinder bore, a wall of an engine block, a wall in a cylinder housing, or a wall in a crankshaft housing.

An example system for preparing a surface of a workpiece for coating or finishing the surface of a workpiece using the methods defined above, where a liquid is provided onto the surface of the workpiece with a nozzle tool, where the nozzle tool has a nozzle body that is rotatable about a spindle axis and displaceable relative to the workpiece in the direction of the spindle axis, where the nozzle tool includes a nozzle chamber and at least one nozzle opening to provide at least one continuous or pulsed fluid jet, an open-loop and/or closed-loop control device being provided for the nozzle tool, to set at least one nozzle-tool operating parameter from the group consisting of a fluid pressure/liquid pressure in the nozzle chamber, a rate of advancement in the direction of the spindle axis, a rotational speed about the spindle axis, a pulse frequency of the fluid jet, a pulse duration of the fluid jet, an amplitude and/or power output of an ultrasonic generator for generating a pulsed fluid jet based on the location of the surface and/or the geometry of the surface and/or the intrinsic or extrinsic properties of the surface of the workpiece or the structural features of another workpiece from a series of workpieces with a surface already prepared for coating that have been measured with a measuring device connected to the open-loop and/or closed-loop control device for the locally resolved measurement of the structural features that are relevant to the adhesion of an applied coating.

An example method includes providing a macroscopic structure onto a surface of the workpiece; and directing a nozzle to cause a fluid jet to flow to the surface to form microstructures on the surface, where the nozzle is directed based on one or more of a location of the surface, the geometry of the surface, intrinsic or an extrinsic properties of the surface, or structural features of another workpiece from a series of workpieces prepared or being prepared for coating. In some examples, the example method also includes coating the surface of the workpiece via a thermal spraying process.

In some examples, providing the macroscopic structure includes machining the workpiece. In some examples, the fluid jet comprises a liquid from the nozzle that is rotatable about a spindle axis and displaceable along the direction of the spindle axis. In some examples, fluid of the fluid jet is mixed with one or more of chemical or abrasive constituents. In some examples, the fluid jet is pulsed.

An example apparatus includes a nozzle to direct a fluid jet to a surface of a workpiece to be coated or prepared, where the surface has a macrostructure defined thereon, and where the nozzle is to define microstructures on the surface. The example apparatus also includes a drive system to rotate the nozzle about a spindle axis and to displace the nozzle in the direction of the spindle axis. In some examples, the example apparatus includes a machining device to define the macrostructure on the workpiece surface.

In some examples, the macrostructure includes one or more of a ridge or a channel. In some examples, the example apparatus includes a sensor to determine a condition of the workpiece, and where the nozzle is directed based on the condition. In some examples, the example apparatus includes a sensor to determine a condition of an additional workpiece, where control of one or more of a fluid pressure in a nozzle chamber, a rate of advancement in the direction of a nozzle spindle axis, a rotational speed about the spindle axis, a pulse frequency of the fluid jet, a pulse duration of the fluid jet, an amplitude and/or a power output of an ultrasonic generator to generate a pulsed fluid jet from the nozzle is based on the condition of the additional workpiece.

This patent arises as a continuation-in-part of International Patent Application No. PCT/EP2014/0062488, which was filed on Jun. 15, 2014, and which claims priority to German Patent Application No. 10 2013 211 324, which was filed on Jun. 17, 2013. The foregoing International Patent Application and German Patent Application are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method for one or more of working or preparing a surface for coating of a workpiece, comprising:
introducing a macroscopic structure into the surface of the workpiece with a tool, wherein after introducing the macroscopic structure, the surface of the workpiece is to be exposed to a fluid for producing microstructures.

2. The method as defined in claim 1, wherein the fluid includes a liquid.

3. The method as defined in claim 1, wherein the macroscopic structure is one or more of a channel or a ridge structure.

4. The method as defined in claim 1, wherein a roughness of the surface is increased at least in certain portions by the exposure to one or more of the fluid or a liquid.

5. The method as defined in claim 1, wherein the fluid is directed as at least one pulsating or continuous fluid jet onto the surface of the workpiece, the fluid jet being produced by one or more nozzles of a nozzle tool, the nozzle tool having a nozzle chamber in which the fluid or the liquid is exposed to a pressure that is greater than 100 bar.

6. The method as defined in claim 1, wherein the fluid includes a liquid including one or more of water, a mixture of water and cleaning agent, a washing alkaline solution, a mixture of water and biocide, an anticorrosive, a water-oil emulsion, or oil.

7. The method as defined in claim 1, wherein the fluid is mixed with one or more of chemical or abrasive constituents.

8. The method as defined in claim 5, wherein the at least one fluid jet is produced by a flat-jet nozzle or a hollow-cone jet nozzle or a full-jet nozzle and has a jet angle, α, which lies between 10° and 60°, and/or the fluid jet with an average jet direction impinges on the surface at a point of impingement at an angle of impingement, β, which corresponds to the angle between the average jet direction and the perpendicular line of the average jet direction to the local tangential plane at the point of impingement, wherein the angle of impingement, β, is approximately 70°≦β≦90°.

9. The method as defined in claim 5, wherein the surface is exposed simultaneously or sequentially to fluid jets, which have a differing jet angle, α, and/or a jet direction with a differing angle of impingement, β, on the surface.

10. The method as defined in claim 5, wherein at least one operating parameter for the nozzle tool is set based on dependence on an intrinsic or extrinsic properties of the surface of the workpiece that is measured or stored in a data memory or is set based on a measured intrinsic or extrinsic properties of the surface of another workpiece of which the surface has already been prepared for coating by exposure to a pulsating or continuous fluid jet from the nozzle tool before the surface of the workpiece.

11. The method as defined in claim 10, wherein the operating parameter for the nozzle tool is a nozzle-tool operating parameter from the group consisting of fluid pressure/liquid pressure in a nozzle chamber, rate of advancement of a nozzle tool in the direction of a spindle axis, rotational speed of a nozzle tool about a spindle axis, pulse frequency of the fluid jet, pulse duration of the fluid jet, amplitude, power output of an ultrasonic generator and/or in that the properties of the surface of the workpiece or of the other workpiece that are determined in a non-destructive measuring process.

12. The method as defined in claim 11 wherein the properties of the workpiece or of the other workpiece is determined in a non-destructive measuring process from the group consisting of profile methods, confocal imaging with a microscope, or imaging with an electron microscope.

13. The method as defined in claim 10, wherein the at least one operating parameter for the nozzle tool is set based on one or more of a location of the surface, a geometry of the surface, intrinsic or extrinsic properties of the surface, measured structural features of the surface of the workpiece that are relevant to the adhesion of an applied coating, an identical workpiece in which the surface has already been prepared for coating, or the relevant structural features of the surface that have been stored in a data memory.

14. The method as defined in claim 1, wherein before and/or after the exposure to a first fluid, the surface of the workpiece is to be flushed with a second fluid different from the first fluid.

15. The method as defined in claim 1, wherein the structure includes a multiplicity of channels with a channel profile that is one or more of rectangular, round, or has at least one undercut.

16. The method as defined in claim 15, wherein the channel profile includes two undercuts.

17. The method as defined in claim 15, wherein the channel profile is at least one of dovetailed shaped or comprises a multiplicity of ridges.

18. A method for finishing the surface of a workpiece, in which the surface of the workpiece is coated, wherein the surface is prepared before coating by a method as defined in one of claims 1 to 12.

19. The method as defined in claim 18, wherein before the workpiece is coated, the surface of the workpiece is dried by treating with one or more of blown air or by vacuum drying.

20. The method for finishing the surface of a workpiece as defined in claim 13, wherein the surface of the workpiece is coated by a thermal spraying process.

21. The method as defined in claim 20, wherein the thermal spraying process includes LDS coating, plasma coating, wire arc spraying or flame spraying.

22. The method for finishing the surface of a workpiece as defined in claim 18, wherein the surface of the workpiece includes a wall of a cylinder bore, a wall of an engine block, a wall in a cylinder housing, or a wall in a crankshaft housing.

23. A system for preparing a surface of a workpiece for coating or finishing the surface of a workpiece using the methods defined in claims 1 to 22, wherein a liquid is provided onto the surface of the workpiece with a nozzle tool, the nozzle tool having a nozzle body that is rotatable about a spindle axis and displaceable relative to the workpiece in the direction of the spindle axis, the nozzle tool including a nozzle chamber and at least one nozzle opening to provide at least one continuous or pulsed fluid jet, an open-loop and/or closed-loop control device being provided for the nozzle tool, to set at least one nozzle-tool operating parameter from the group consisting of a fluid pressure/liquid pressure in the nozzle chamber, a rate of advancement in the direction of the spindle axis, a rotational speed about the spindle axis, a pulse frequency of the fluid jet, a pulse duration of the fluid jet, an amplitude and/or a power output of an ultrasonic generator for generating a pulsed fluid jet based on a location of the surface and/or a geometry of the surface and/or intrinsic or extrinsic properties of the surface of the workpiece or structural features of another workpiece from a series of workpieces with a surface already prepared for coating that have been measured with a measuring device coupled to the open-loop and/or closed-loop control device for the locally resolved measurement of the structural features that are relevant to the adhesion of an applied coating.

24. A method to prepare a workpiece for coating comprising:
providing a macroscopic structure onto a surface of the workpiece; and
directing a nozzle to cause a fluid jet to flow to the surface to form microstructures on the surface, wherein the nozzle is directed based on one or more of a location of the surface, a geometry of the surface, an intrinsic or an extrinsic properties of the surface, or structural features of another workpiece from a series of workpieces prepared or being prepared for coating.

25. The method as defined in claim 24, further including coating the surface of the workpiece via a thermal spraying process.

26. The method as defined in claim 24, wherein providing the macroscopic structure includes machining the workpiece.

27. The method as defined in claim 24, wherein the fluid jet includes a liquid from the nozzle that is rotatable about a spindle axis and displaceable along the direction of the spindle axis.

28. The method as defined in claim 24, wherein fluid of the fluid jet is mixed with one or more of chemical or abrasive constituents.

29. The method as defined in claim 24, wherein the fluid jet is pulsed.

30. An apparatus comprising:
a nozzle to direct a fluid jet to a surface of a workpiece to be coated or prepared, the surface having a macrostructure defined thereon, the nozzle is to define microstructures on the surface; and
a drive system to rotate the nozzle about a spindle axis and to displace the nozzle in the direction of the spindle axis.

31. The apparatus as defined in claim 30, further including a machining device to define the macrostructure on the workpiece surface.

32. The apparatus as defined in claim 30, wherein the macrostructure includes one or more of a ridge or a channel.

33. The apparatus as defined in claim 30, further including a sensor to determine a condition of the workpiece, wherein the nozzle is directed based on the condition.

34. The apparatus as defined in claim 30, further including a sensor to determine a condition of an additional workpiece, and wherein control of one or more of a fluid pressure in a nozzle chamber, a rate of advancement in the direction of a nozzle spindle axis, a rotational speed about the spindle axis, a pulse frequency of the fluid jet, a pulse duration of the fluid jet, or an amplitude and/or power output of an ultrasonic generator to generate a pulsed fluid jet from the nozzle is based on the condition of the additional workpiece.
